(19) United States
(12) Patent Application Publication
(10) Pub. No.: US 2023/0213891 A1
(43) Pub. Date: Jul. 6, 2023

(54) A METHOD AND DISPLAY APPARATUS FOR REDUCING HOLOGRAPHIC SPECKLE

(71) Applicant: VividQ Limited, London (GB)

(72) Inventors: Alfred James NEWMAN, London (GB); Indi PRITCHARD, London (GB); Darius Martin SULLIVAN, London (GB); Sapumal Jaliya SENANAYAKE, London (GB)

(21) Appl. No.: 17/928,540

(22) PCT Filed: Jun. 2, 2021
(86) PCT No.: PCT/GB2021/051353

§ 371 Date: Nov. 29, 2022

(30) Foreign Application Priority Data
Jun. 3, 2020 (GB) 2008316.8

(51) Int. Cl. G03H 1/32; G03H 1/26

(52) U.S. Cl. CPC G03H 1/32; G03H 1/2645; G03H 2001/266; G03H 2210/32; G03H 2210/45; G03H 2223/14; G03H 2240/11

(57) ABSTRACT

A method and display apparatus for reducing holographic speckle when displaying holographic images are described. A target image (10) is decomposed into input images (11). A first input image includes higher spatial frequency components of the target image and is imaged using a first display method (12) to generate a first holographic display image. The second input image includes lower spatial frequency components of the target image and is imaged using a second display method (12) to generate a second display image. The first and second display images are combined for display to a user. The second display method (12) is adapted to reduce holographic speckle or include no holographic speckle compared to the first holographic display method (12) thereby reducing holographic speckle in the combined display image (13).

### TECHNICAL FIELD

The present invention relates to a method and display apparatus for reducing holographic speckle.

### BACKGROUND

A Computer-Generated Hologram (CGH) is a representation of a light field produced by a coherent or at least partially coherent laser reflecting off objects in a scene, preserving depth and focus information of the scene. Although often used for three-dimensional scenes, CGH can also be used to display two-dimensional images. Each pixel in the target scene represents a point emitter of a given intensity at a given depth. Each pixel also has a target phase value, which encodes the scattering properties of a surface.

A hologram may be generated in a display apparatus by reflecting laser light off a spatial light modulator, which modulates the incident light in accordance with a computer-generated image in order to generate the impression of the scene for a user. Whilst digital holography is an exciting area for the display of holograms, there is a challenge in managing speckle noise that appears in the holograms, especially computer-generated holograms or digital holography.

Several techniques are known for mitigating noise in holograms. These include use of iterative algorithms, such as the Gerchberg-Saxton algorithm, to reduce speckle noise. However, this technique is computationally expensive and difficult to implement for holograms of three-dimensional scenes. Another option is to introduce hardware into the holographic display apparatus in order to reduce speckle noise. However, this approach has the disadvantage that it tends to come at the cost of resolution of the displayed holographic image.

### SUMMARY

According to a first aspect of the present invention, there is provided a method for reducing holographic speckle when displaying an image, the method comprising: displaying the image by combining a first holographic display image and a second display image, the first holographic display image comprising higher spatial frequency components of the image and being generated using a first holographic display method and the second display image comprising lower spatial frequency components of the image and being generated using a second display method, wherein the second display method is adapted to reduce holographic speckle or include no holographic speckle compared to the first holographic display method.

The first holographic display image may comprise higher frequency components than the second display image if, in general, the spatial frequencies within the first holographic image are higher than the spatial frequencies within the second display image. There may be some overlap in spatial frequencies present in the first holographic image and the second display image. For example, the average spatial frequency within the first holographic image may be higher than the average spatial frequency within the second display image. Other statistical measures may be used. For example, the peak of a distribution of frequencies may be at a higher frequency within the first holographic display image than the peak within the second display image. Correspondingly, the second display image may comprise lower frequency components than the first holographic display image if, in general, the spatial frequencies within the second display image are lower than the spatial frequencies within the first holographic image. The average spatial frequency within the second display image may be lower than the average spatial frequency within the first holographic image. Other statistical measures may be used. For example, the peak of a distribution of frequencies may be at a lower frequency within the second display image than the peak within the first holographic display image.

Embodiments of the invention may display images including lower holographic speckle due to the reduction of holographic speckle in the second display image. Additionally, embodiments may be able retain imaging resolution because the first holographic display method includes less or no speckle reduction compared to the first holographic display method.

In some embodiments the displayed image is a three-dimensional image. In other embodiments, the displayed image is a two-dimensional image.

The first holographic display image may be generated based on a first input image and the second display image may be generated based on a second input image, wherein all intensity values of the first and second input images are non-negative (a non-negative number is positive or zero). In this way the first holographic display image may be additively combined with the second display image. This may be useful when images are incoherently combined.

The method may comprise decomposing a target image to generate the first input image and second input image, wherein the first input image and second input image are generated so that the displayed image perceived by a user is substantially the same as the target image.

The method may comprise decomposing a target image to generate the second input image including lower frequencies of the target image and generating the first input image based on the second input image and the target holographic image. The decomposition of the target image to generate the second input image may include applying a minimum value filter to the target image. The first input image may be obtained by applying a blurring function to the second input image and subtracting the blurred second input image from the target image. The blurring function may be a blurring function that is selected to be similar to or the same as a blurring associated with the second display method.

Other embodiments may include a step of decomposing a target image to generate the first input image, the second input image and an intermediate input image, wherein the first input image includes higher spatial frequencies of the target image than the intermediate input image, and the intermediate input image includes higher spatial frequencies of the target image than the second input image, wherein displaying the image is performed by combining the first holographic display image, the second display image and a third display image, the third display image having been generated using a third display method to display the intermediate input image. In some such embodiments, the target image may be decomposed to generate the second input image, a first blurring function may be applied to the second input image and the blurred second input image may be subtracted from the target image to generate a second target image. The second target image may be decomposed to generate the intermediate input image, a second blurring function may be applied to the intermediate input image and the blurred intermediate image may be subtracted from the second target image to generate the first input image. The first blurring function may be selected to be similar to or the same as a blurring associated with the second display method. The second blurring function may be selected to be similar to or the same as a blurring associated with the third display method. In other embodiments, the target image may be decomposed to generate a second target image including lower spatial frequencies of the target image, a first blurring function may be applied to the second target image and the blurred target image may be subtracted from the target image to generate the first input image. The second target image may be decomposed to generate the second input image, a second blurring function may be applied to the second input image and the blurred second input image may be subtracted from the second target image to generate the intermediate input image.

The first display image and second display image may be combined by displaying the first and second display images in a time sequence so that a viewer perceives the target image as a combination of the first display image and the second display image. The time sequenced display may be performed at a frequency that is preferably equal to or higher than 30 hertz and more preferably equal to or higher than 60 hertz. Higher frequencies may be desirable so that a target image is perceived at a higher frame rate, for example, when there are two images to combine into a target image, the time-sequenced display may operate at 120 hertz so that the target image is perceived at a 60 hertz.

The first display image and second display image may be combined by simultaneously displaying the first and second display images so that a viewer simultaneously receives light from first and second display images.

The second display method may comprise a second holographic display method in which the second display image is generated having only a single depth. Such embodiments may have a lower computational burden due to the lack of varying depth values.

According to a second aspect of the present invention there is provided a display apparatus for reducing holographic speckle when displaying an image. The display apparatus is configured to display the image by combining a first holographic display image comprising higher spatial frequency components of the image and a second display image comprising lower spatial frequency components of the image. The display apparatus has a first operation mode to generate the first holographic display image and a second operation mode configured to generate the second display image, wherein the second operation mode is configured to reduce holographic speckle or include no holographic speckle compared to the first operation mode. The image may be a three-dimensional image or a two-dimensional image.

The second operation mode may be configured to generate images with greater blur than the first operation mode.

The display apparatus may be configured to display the first holographic display image and second display image in a time-sequence or simultaneously so that they are perceived as a combination of the first holographic display image and second display image.

In some embodiments the display apparatus comprises a holographic image generator, the holographic image generator comprising an optical blurring component; and wherein the second operation mode uses the holographic image generator and the optical blurring component to reduce holographic speckle in the second display image.

In some embodiments the display apparatus comprises a holographic image generator, the holographic image generator comprising a processor and a memory configured to process an input image in order to reduce holographic speckle; and wherein the second operation mode uses the holographic image generator.

The display apparatus may comprise a non-holographic two-dimensional display. In such embodiments, the second operation mode may use the non-holographic two-dimensional display. In such embodiments, the lower frequencies included in the second display image mean that the defocussing effect caused by using a non-holographic display may be small.

The display apparatus may comprise a phase-only holographic display. In such embodiments the first operation mode may use the phase-only holographic display.

The display apparatus may comprise a holographic display and a variable diffuser provided in an optical path of the holographic display. In such embodiments the first operation mode and the second operation mode may use the holographic display and have different blur characteristics in a time sequence by varying a level of diffusion provided by the variable diffuser. The display of the first holographic display image and the second display image may be synchronised with the time sequence of varying diffusion provided by the variable diffuser.

The display apparatus may comprise a controller configured to separate image data and associated diffusion data indicative of a level of diffusion required in the image, and to control display of an image with diffusion according to the diffusion data.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a diagram giving an overview of a method of processing of a target image;

FIG. 2 is a chart showing a method for decomposing the target image;

FIG. 3 consists of three images of a horse to which varying levels of speckle reduction processing have been applied;

FIG. 4 is a diagram of a phase-only holographic imaging apparatus;

FIG. 5 is a diagram of a phase-only holographic imaging apparatus including an optical diffusing element;

FIG. 6 illustrates options for adapting the apparatus shown in FIG. 5 to allow the amount of diffusion to be varied rapidly;

FIG. 7 is a diagram showing a stepped diffuser element; and

FIG. 8 depicts a schematic block diagram of an example apparatus to synchronize display of images with selectable diffusion levels.

### DETAILED DESCRIPTION

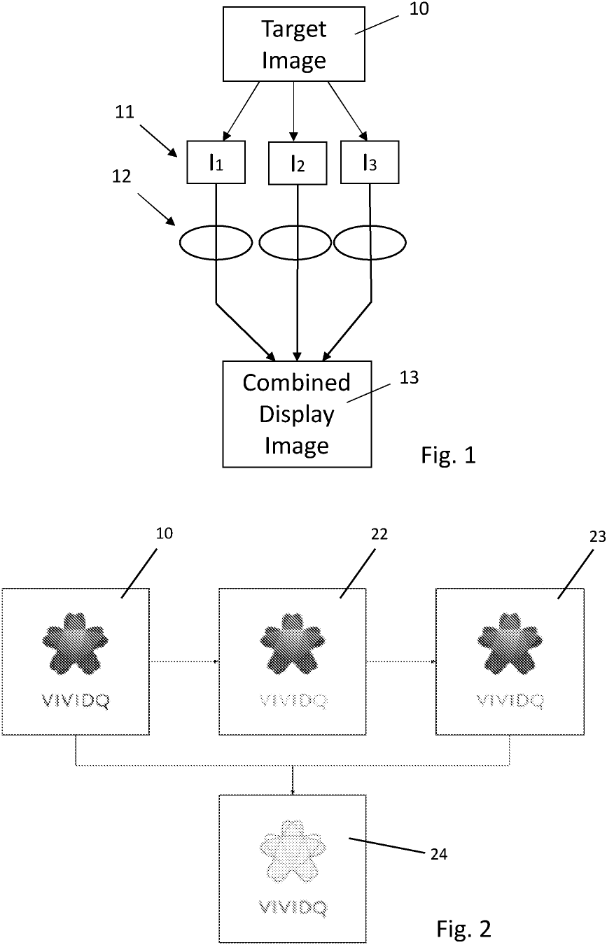

FIG. 1 is a diagram giving an overview of a method of processing of a target image 10 to generate a combined display image 13. The processing is performed by a digital holographic display apparatus that will generate the combined display image 13 to be viewed by a user. The target image 10 is a 3-dimensional image data set including image pixels each having an intensity value and a depth value. In a monochromatic display the target image 10 is an image to be displayed. In a colour holographic display, the target image 10 represents one colour of an image to be displayed, such as one of a Red, Green, or Blue image. In this embodiment, the target image 10 includes a single pixel value at each spatial location within the image and a single depth value. More generally, a 3-dimensional image data set could include multiple image pixels at a single spatial location, each image pixel having different depth values. The target image 10 is an intensity map and it should be noted that no gamma correction has been applied to the target image 10.

The target image 10 is decomposed by the holographic display apparatus into multiple input images 11, each of which is an intensity map. The steps of the decomposition process are performed by a processor and memory within the holographic display apparatus in accordance with program instructions stored in the memory. The target image is decomposed into three input images I₁ to I₃ as shown in FIG. 1, but in general two or more input images 11 may be formed. The input images 11 are then subjected to imaging by imaging processes 12 to generate multiple display images. The imaging processes 12 are shown separately in FIG. 1 and may be performed by separate display systems. However, two or more of the imaging processes 12 may be different operating modes of a single display system and examples of this will be given below. The light from the display images are combined to generate the combined display image 13. The combination of the multiple display images may be performed by optically combining the light from the multiple display images or by sequentially displaying the multiple images at a speed that is high enough for a viewer to perceive the images as combined. For example, the display images may be displayed in sequence at a frequency of 60 hz or higher which may be enough for the images to be perceived by a viewer as a single image.

The decomposition technique may be selected such that each of the generated input images 11 have non-negative intensity values because the input images 11 are imaged by the imaging processes 12 and combined incoherently to generate a combined display image 13. This is because when combining the display images, it is possible to add the images together but difficult or impossible to take light away unless coherent techniques are used for the combination.

FIG. 2 is a chart showing an example method for decomposing a target image 10, which is to be displayed to a user, to generate two input images 22 and 24. The target image 10 is first subjected to low-pass filtering. In the embodiment, this involves use of a N×N minimum filter. For example, a 9×9 minimum filter may be used in which an array of 9×9 pixels around a target pixel is examined and the minimum pixel value within that array is selected as the value for the target pixel. Applying this filter across the entire target image 10 generates a low-pass image 22.

The low-pass image 22 is subjected to convolution with a blur kernel. The blur kernel is preferably selected to be a close approximation to the blur characteristics that the unblurred low-pass image 22 will be subject to as an input image being imaged by an imaging process 12. Ideally, the blur kernel should be normalized to sum to 1, be non-negative everywhere, and have a shape that can easily be processed in hardware. The blurred low-pass image 23 generated by applying the blur kernel approximates a first display image generated by an imaging process 12 displaying the unblurred low-pass image 22. A suitable blurring kernel might be a flat-top function or a truncated gaussian function. The flat-top function is expected to provide better speckle reduction but may be more difficult to recreate in hardware.

A high-pass image is generated by subtracting the blurred low-pass image 23 from the target image 10. The high-pass image 24 is used as a first input image and is imaged by a first imaging process 12 and the unblurred low-pass image 22 is used as a second input image and is imaged by a second imaging process 12. In this way, the decomposition produces input images 11 that have minimal content either side of the cut-off frequency of the blur kernel, so that detail is not lost when the decomposed images are displayed by the imaging process 12.

As mentioned above, the target image 10 includes depth values associated with the pixels. The input images 11 generated during decomposition inherit the depth values from the target image 10 without the depth values needing to be considered during decomposition.

The method described above in connection with FIG. 2 includes a single decomposition to generate the unblurred low-pass image 22 and the high-pass image 24 as input images 11. In a further embodiment, the method can be iterated to generate multiple input images 11 by using different N×N minimum filters. For example, the method shown in FIG. 2 may initially be performed using a target image and a 27×27 minimum filter. As described above, this generates a first unblurred low-pass image and a first high-pass image. The unblurred low-pass image forms a third input image in this embodiment. The first high-pass image may then be taken as the target image for a second decomposition using a 9×9 minimum filter. The second decomposition uses the same method as the first decomposition, which is illustrated in FIG. 2. A second unblurred low-pass image is generated by the 9×9 filter, which forms the second input image. The second unblurred low-pass image is then subjected to a blur kernel to generate a second blurred low-pass image and the second blurred low-pass image is subtracted from the first high-pass image (second target image). The resulting second high-pass image forms the first input image. The blur kernel used to blur the third input image is preferably selected to correspond to the blur introduced by the imaging process 12 used to display the third input image. Correspondingly, the blur kernel used to blur the second input image is preferably selected to correspond to the blur introduced by the imaging process 12 used to display the second input image.

The method described in the preceding paragraph generates three input images 11, the first input image including higher frequencies of the target image 10 than the second input image and the second input image including higher input frequencies than the third input image. The reader will appreciate that the process could be iterated by any number of times using a series of different-sized minimum filters and sequentially decomposing the generated high-pass image to produce a desired number of input images 11. In this way, successive images corresponding to different frequency ranges in the target image are produced. Initially an image with the lowest frequencies is produced and each iteration produces images with successively higher frequencies.

Returning to FIG. 1, the first input image in each of the embodiments described above is the high-pass image and includes higher frequencies of the target image 10 than the unblurred low-pass image. In the embodiment described with two decompositions, the first input image (high-pass image from the second decomposition) has higher frequencies than the second input image (unblurred low-pass image from the second decomposition). The second input image (unblurred low-pass image from the second decomposition) has higher frequencies than the third input image (unblurred low-pass image from the first decomposition).

The imaging process(es) 12 used to generate second and subsequent display images from the second and subsequent input images 11 may be selected to have greater speckle reduction capabilities compared to an imaging process 12 used to generate the first display image from the first input image. For example, the imaging process 12 used to display the first input image may be a phase-only holographic display without a de-speckling hardware element, such as a vibrating mirror. Alternatively, the imaging process 12 used to display the first input image may include a de-speckling hardware element, such as a vibrating mirror, but the de-speckling hardware element may be de-activated. A second or subsequent imaging process 12 used to display the second or subsequent input image may be a phase-only holographic display including an active de-speckling hardware element, such as a vibrating mirror. This imaging process 12 tends to generate a display image with better speckle noise properties, but at the expense of some loss of resolution. The second or subsequent imaging process 12 may further include a software processing step of applying Gerchberg-Saxton algorithm to the input image to calculate a phase only hologram. The use of Gerchberg-Saxton algorithm with phase-phase only holograms is known and is discussed, for example, in ‘A Practical Algorithm for the Determination of Phase from Image and Diffraction Plane Pictures’, R. W. Gerchberg and W. O. Saxton published in OPTIK Vol. 35 (No.2) 237-246 (1972) and ‘Speckle-suppressed phase-only holographic three-dimensional display based on double-constraint Gerchberg-Saxton algorithm’, by Chenliang Chang and Jun Xia, in Applied Optics, 54(23): 6994-7001, published September 2015.

In some embodiments, an imaging process 12 for the second or subsequent input image is selected to be a two-dimensional imaging process. In one example the imaging process 12 may be a phase-only holographic imaging process in which the depth data in the second input image is replaced with a single depth value in order to reduce computational processing burden. In other embodiments, the two-dimensional imaging process 12 may be a non-holographic display such as a flat panel display. The use of a non-holographic display method or the removal of depth variation in a holographic display method may be acceptable for the display of the second or subsequent display image because the effect of the de-focus may be low for lower frequency components of the target image 10. In other words, it is the higher frequency components of the target image which convey the most depth information so lost depth information in the lower frequency components may not be perceived by a viewer or may have a reduced impact on the depth perception when combined into the target image.

An image decomposition technique has been described that uses N×N minimum filters to generate low-pass and high-pass input images 11. However, it should be appreciated that this is not the only possible image decomposition technique. For example, image decomposition techniques based on edge detection to identify high-frequency portions of the image or using frequency-separation techniques are also possible.

The imaging processes 12 described above are selected so that second and subsequent input images 11 containing lower frequencies of the target image 10 are subjected to a level of speckle noise reduction. The reason for this is that speckle reduction techniques, such as use of a de-speckling hardware element, tend to reduce speckle noise at a cost of reduced image resolution. Accordingly, by displaying the higher frequencies in the first image using a phase-only holographic method without de-speckling hardware, the loss of resolution is reduced while the benefits of speckle noise reduction in the 3D image can also be obtained.

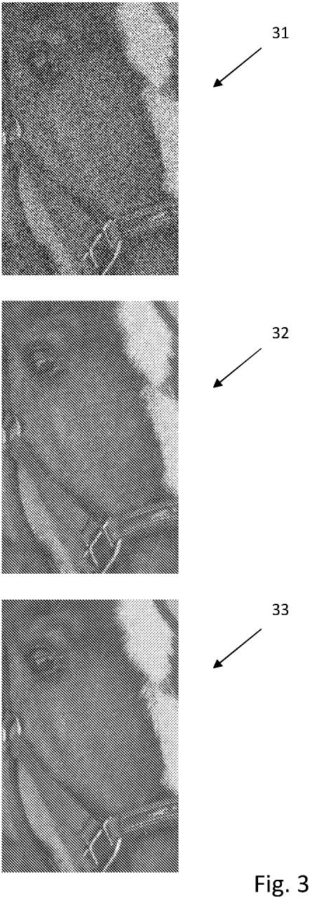

To demonstrate the benefits of the embodiments, FIG. 3 consists of three images of a section around the eye of a horse. The top image 31 is a simulation of a phase-only hologram (depicted in two dimensions in FIG. 3) including holographic speckle. The middle image, 32, is a simulation of a hologram generated after performing a single image decomposition of the type described in connection with FIG. 2 using a 9×9 minimum filter to generate the unblurred low-pass image and, after subsequent blurring using a blurring kernel, the high-pass image. The middle image 32 exhibits significantly less speckle noise than the top image 31.

The bottom image 33 in FIG. 3 is a simulation of a holographic image after three image decompositions using a 27×27, 9×9, and 3×3 minimum filter in sequence as described above and is therefore a combination of four images. There is a further significant improvement in image quality, which can be seen most clearly in the area of the horse’s eye in the FIG. 3.

Examples of hardware that may be used to implement the imaging processes 12 will now be described. As previously noted, the imaging process 12 may be implemented as separate modes using different imaging systems or different modes of operation of a single hardware configuration.

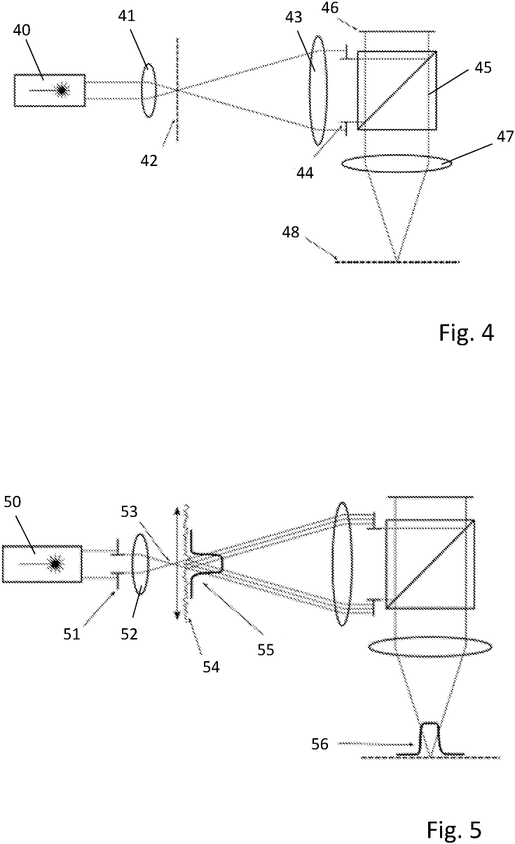

FIG. 4 is a diagram of a phase-only holographic imaging apparatus. An imaging process 12 performed by the phase-only holographic imaging apparatus may be suitable for display of the first input image containing higher frequencies of the target image 10 because it does not include any de-speckling hardware. A light source 40 generates a coherent laser beam. The laser beam is focussed by a first lens 41. The dotted line 42 shown in FIG. 4 shows a focus plane of the laser light. The laser beam is collimated by a second lens 43 before passing through a laser aperture 44. A beam splitter 45 directs the beam onto a spatial light modulator 46, which modulates the light in accordance with an input image, such as a first input image. The light from the spatial light modulator returns through the beam splitter to a focussing element 47. The beam splitter 45 may be a polarising beam splitter in which case a further optical element (not shown) to adjust the polarisation of the light may be inserted in front of the spatial light modulator 46. The light from the spatial light modulator is focussed by the focussing element 47 to form an image at the imaging plane 48.

The laser light generated by the laser source 40 is typically gaussian in intensity profile. The image formed at the imaging plane 48 is a Fourier transform of the phase profile at the spatial light modulator 46 convolved with the laser intensity at the focus plane of the laser light 42. The image is additionally convolved with a Sinc function that is the Fourier transform of the laser aperture 44. Typically, it is the laser aperture 44 that is the limit on overall resolution. It is noted here that, if the beam profile of the laser is not ideal, then the blur kernel used in the decomposition algorithm may be adapted to account for the actual laser beam profile.

As noted above, the holographic imaging apparatus of FIG. 4 will tend to generate speckle noise in the displayed image. However, because the intensity of the higher frequency components in the first input image tends to be relatively low, the background noise is generally acceptable.

FIG. 5 is a diagram of a phase-only holographic imaging apparatus including an optical diffusing element 54. This phase-only holographic imaging apparatus may be suitable for displaying a second or subsequent input image because the diffusing element 54 is selected to reduce speckle noise and, in the process, becomes the limiting factor on resolution.

A laser source 50 generates a laser beam that is incident on an aperture 51. The aperture 51 is a hardware element that serves to set the source profile of the laser light and may be omitted in some examples. The laser beam is then focussed by a first lens 52 on a focus point 53 in front of the optical diffusing element 54, which takes the form of a spinning diffuser. A spinning diffuser is used because if a static diffuse surface is used to diffuse the laser light, the convolution kernel of the static diffuser has a fixed random phase and the image in the image plane 56 after the spatial light modulator will retain speckle. However, if the diffuse surface is dynamic then the blur kernel has a dynamically changing phase profile, and the speckle caused by the diffuse surface dynamically changes. When time-averaged, the speckle noise is reduced, and the blur kernel takes a profile 55 from the laser source plane 53. As mentioned above, the profile of the laser source may be set with the addition of an aperture 51.

The diffused light is collimated by a second lens and formed into an image in the image plane 56 in the same way as described in connection with FIG. 4. Accordingly, the description of the corresponding elements of FIG. 5 is not repeated.

As explained in connection with FIG. 1, the input images 11 are imaged by the imaging processes 12 and the display images are combined to generate a combined display image 13. This may be performed in a single hardware arrangement in different operating modes by sequentially displaying the display images to give the impression of a combined display image 13 to a viewer. The level of the blurring is synchronised with the display of the different input images 11. The level of blurring preferably varies between no blurring (a point-source) and a level of blurring enough to generate a blurred low-pass image with minimal speckle.

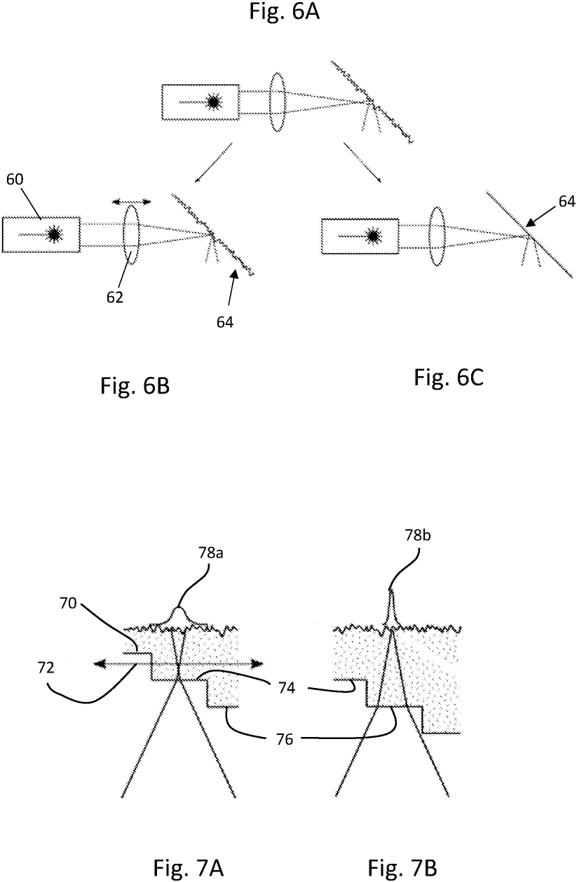

An example of how to display a sequence of images with varying levels of optical blurring (different operating modes) will now be described with reference to FIG. 6. FIG. 6 depicts part of a phase-only holographic imaging apparatus according to FIG. 5, but which in this case uses a vibrating mirror as the optical diffusing element instead of the spinning diffuser of FIG. 5. Corresponding elements in FIG. 6 are given the same reference number as FIG. 5, incremented by 10. The spinning diffuser of FIG. 5 is replaced with an electrically controlled diffuser in the form of a ultrasonic MEMS mirror 64. Ultrasonic MEMS mirrors are commercially available, such as those manufactured by Dyoptyka. When active, the ultrasonic mirror 60 provides a time-varying diffuse surface as shown in the top image of FIG. 6A.

FIG. 6 shows a technique for adapting the holographic imaging apparatus to allow the amount of diffusion to be varied rapidly as different input images 11 are imaged.

FIG. 6A shows the laser 60 focussed by the first lens 62 just before the vibrating mirror 64. The vibrating mirror imparts a blur to the resulting image, reducing image speckle at the expense of resolution.

FIG. 6B shows that the first lens 62 may be adapted to be controllably driven in order to vary the focus plane of the laser beam and hence the degree of diffusion by the vibrating mirror 64. The driving to control the first lens 62 may be done by a voice coil, use of piezoelectric material, a liquid lens or the like. As depicted in FIG. 6B, the laser light may be focussed onto the vibrating mirror 64 in order to generate minimal blurring and create a close-to-point light source. The level of blurring applied is less than the level of blurring in FIG. 6A.

The laser light may be focussed by the drivable lens 62 at one or more positions in front of the vibrating mirror 64 in order to increase blur and diffuse the light (such as in FIG. 6A) or reduce the blur (such as in FIG. 6B).

In examples where a target image is decomposed into two images, the holographic imaging apparatus may be operated as according to FIG. 6B for the first input image (reduced blur) and according to FIG. 6A for the second input image (increased blur). In this way, the level of blur is controlled by the focus point of the first lens 62. In examples where a target image is decomposed into three or more images, varying the focus point of the first lens 62 is suitable for displaying second and subsequent images in which blur is introduced in the display image. As the position of focus of the laser light can be controlled, it is possible to provide a number of different levels of diffusion depending upon the number of input images 11 (and hence image decompositions) desired. The drivable lens 62 is moveable quickly to provide the different levels of diffusion in synchronization with the display of different input images 11 by the spatial light modulator 46. By displaying a rapid sequence of the input images 11 with different amounts of diffusion, a viewer may perceive the combined display image 13.

FIG. 6C depicts the situation when the power to the ultrasonic mirror is turned off so that it ceases to vibrate, and a smooth reflective surface is then provided. This arrangement allows two states of diffusion through control of the optical diffusing element. For example, the optical diffusing elements may be selectively turned on and off in sequence when the target is decomposed into two images.

Some examples may combine the operation in FIGS. 6A, 6B and 6C, by providing both a driveable lens with an optical diffusing element which can be selected activated. When a target image is decomposed into three images, operation according to FIG. 6C can be adopted for the first input image (the highest frequency image) to preserve image detail, operation according to FIG. 6B for an intermediate image, and operation according to FIG. 6A or a second image (the lowest frequency image).

Although described in conjunction with a vibrating mirror as the optical diffusing element 64, the techniques of FIG. 6 can be applied to other optical diffusing elements. For example, they can be applied using a spinning disc optical diffuser that has a diffuse surface and a smooth region within the diffuse surface. In that case, causing the spinning disc optical diffuser to stop spinning in an orientation in which the laser light is incident upon the smooth region of the disc optical diffuser will have a similar effect to that discussed above with reference to FIG. 6C when the vibrating mirror is turned off.

FIG. 7 illustrates a further embodiment in which the variable diffusion is provided by a stepped diffuser element 70 through which laser light to generate a holographic image is transmitted. This stepped diffuser arrangement may be introduced into the apparatus described in connection with FIG. 5 in place of the spinning diffuser 54. The stepped diffuser element 70 is translatable horizontally as shown by the double-headed arrow 72 in FIG. 7A. The horizontal translation has two components.

Firstly, within a step of the stepped diffuser, the stepped diffuser is oscillated in order to provide a time varying diffusion kernel which has the effect of time averaging the diffusion pattern and reducing speckle noise.

Secondly, when different amounts of diffusion (or no diffusion) is required the stepped diffuser may be translated horizontally between steps as shown between FIG. 7A and FIG. 7B. In FIG. 7B, the stepped diffuser element 70 has been translated to the left so that the light from the laser is incident on step 76 rather than step 74. This changes the focal point of the laser because of the different refractive index of the stepped diffuser element relative to air. As shown in FIG. 7B, the laser light is focussed closer to the exit surface of the stepped diffuser element and so less diffusion or blurring is produced. These are represented graphically by a laser light distribution profile 78b in FIG. 7B being sharper than the distribution profile 78a of FIG. 7A.

In other words, although the position of a focussing lens is not changed, the different depth of the stepped diffuser changes the focal point. As shown in FIG. 7A, the laser light is focussed further from the front of an exit or diffuser surface of the stepped diffuser 70. FIG. 7B shows a situation in which the laser light is focussed closer to the exit or diffuser surface of the stepped diffuser 70. This second configuration has an effect similar to that of a point source.

In some examples, when no diffusion is required, the stepped diffuser element 70 may be removed from the light path completely, such as by continuing horizontal translation.

Holographic display apparatuses are described above that allow display of holographic images with time varying amounts of diffusion or blur introduced in order to control speckle noise. However, only the first image including the higher frequency components of the target image 10 may require holographic display. The second and any subsequent input images 11 containing lower frequencies of the target image 10 may be displayed by other means. For example, an input image containing sufficiently low frequencies could be displayed using a non-holographic two-dimensional display such as an LCD, DMD, OLED or microLED display. This is possible because any defocus blur due to loss of depth information will not be perceivable due to the already blurred nature of that decomposed image as a result of the low-pass filter. The size of blur kernel for which this is possible is approximately 4D²/ Cλ pixels, where D is pupil diameter, C is close focus distance, and λ is wavelength. For typical values this will be a kernel size of the order 100 pixels wide. Simultaneously displaying images from a non-holographic display and a holographic display is possible using various techniques.

One technique would be by use of a bird-bath style optical combiner known from head-mounted display technology. In this way light from two images, a first holographic image and a second two-dimensional non-holographic image can be combined and viewed simultaneously. In other embodiments, both displays could be holographic displays, a first including an active de-speckling function for displaying second and subsequent input images 11 and the other not including an active de-speckling function for displaying the first input image. Again, these two displays could be configured for combined display using an optical combiner.

In embodiments in which two or more decompositions are performed on the target image 10 to generate three or more input images 11, the images after the first input image and before the final input image will contain mid spatial frequencies. These frequencies don’t tend to suffer due to loss of resolution. Accordingly, it is typically preferable to display these input images 11 using a holographic display apparatus including at least one hardware de-speckling element of the types described above (spinning diffuser, ultrasonic mirror, or stepped diffuser).

In other embodiments, the input images 11 with mid-frequency content (an intermediate blur kernel) may be displayed using light-field techniques (multiple incoherent images displayed into multiple sub-pupils). This is possible because the diffraction-limit on the reduced pupil is acceptable for the reduced resolution of these decomposed input images 11.

The above techniques are of general application and the display apparatus can be implemented in a head-mounted display, a head-up display, a display panel or other display type.

Phase-only holographic imaging apparatuses have been described above, including the apparatuses described with reference to FIGS. 4 and 5. At the time of writing, many spatial light modulators are phase-only. However, the techniques discussed herein are applicable in the case in which an amplitude-only spatial light modulator or a phase and amplitude spatial light modulator is used. The methods and apparatus described above don’t change in this case, but the capabilities of the spatial light modulator are changed to include modulation of light amplitude.

The above embodiments are to be understood as illustrative examples of the invention. Further embodiments of the invention are envisaged. For example, the display apparatus embodiments described in connection with FIGS. 5 to 7 could be combined with a software application of Gerchberg-Saxton algorithm to the second or subsequent input images 11 to reduce speckle noise in the resulting display images. This may have the effect of further reducing noise in the lower frequency input images 11, but at the cost of additional computational burden.

In the embodiment above in which multiple decompositions are performed, the N×N minimum filters were applied in an order in which the largest N×N minimum filter is applied first followed by smaller N×N minimum filters. For example, a 27×27 minimum filter may be applied and subsequently the high-pass image may be further decomposed using a 9×9 minimum filter. The resulting high-pass image from that 9×9 minimum filter decomposition may be further decomposed using a 3×3 minimum filter. In other embodiments, rather than further decomposing the high-pass image, the low-pass image may be further decomposed. For example, a 3×3 minimum filter may be first applied to generate a high-pass image and a low-pass image. The low-pass image may be further decomposed using a 9×9 minimum filter to generate a further high-pass image and low-pass image. Finally, the low-pass image may be further decomposed using a 27×27 minimum filter to generate another high-pass and low-pass image. Of course, 27×27, 9×9 and 3×3 are simply chosen as examples and any suitable N×N minimum filter set may be used.

As described above, the final input image contains the lowest frequencies of the target image 10. As the resolution of this image is typically low, the display of the last input image or last several images containing the lowest frequencies may be performed with reduced spatial resolution in order to reduce computational burden. A reduction in resolution may also be applied to the depth and/or intensity values of the lower frequency images. Accordingly, the depth and/or intensity values may be quantized to have a lower resolution in the mid and/or lower frequency images (second or subsequent input images).

The above embodiments have discussed display of a single target image. However, it will be appreciated that video is a sequence of images and that the above techniques are of equal application to three-dimensional video display. Accordingly, the term ‘image’ in the description above should be understood to include an image forming part of a video sequence.

In the above described embodiments, the steps of decomposing the target image 10 to generate input images 11 are performed by a processor and memory in the holographic display apparatus. In further embodiments, the processing of the target image could be performed by an application specific circuit. In other embodiments, the holographic display apparatus may be connected to a separate information processing apparatus, such as a PC, a server or the cloud, and the processing to generate the input images 11 from the target image 10 may be performed by the information processing apparatus.

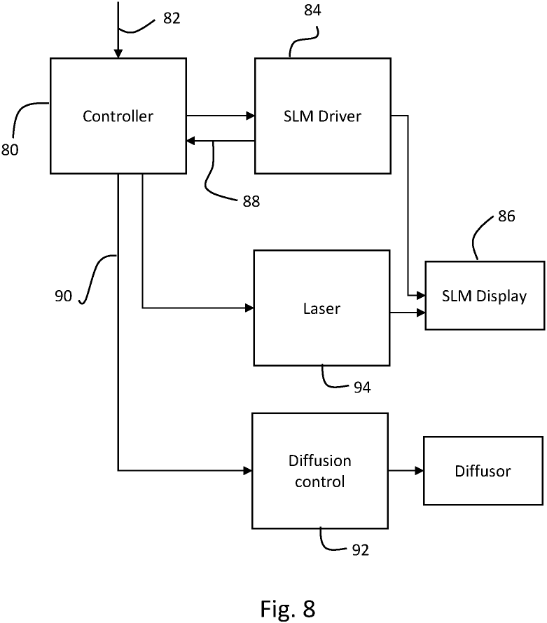

Referring now to FIG. 8, an example of hardware control to synchronize the display of input images 11 with appropriate diffusion characteristics will be discussed. FIG. 8 depicts a schematic block diagram of an example apparatus to synchronize display of images with selectable diffusion levels. As mentioned above, for example with reference to FIGS. 6 and 7, the input images 11 may be displayed in a time sequence by the same hardware operating in different diffusion modes over time. FIG. 8 is a block diagram of a system which is operative to synchronise the operation of a diffuser with the display of an image.

A controller 80 receives an input 82 of the images 11 for display, along with diffusion data indicative of a required diffusion level to apply during display. For example, with reference to FIG. 1, the controller 80 may receive the images I₁, I₂ and I₃ over the input interface 82. The diffusion data may be included as metadata associated with each image. In some examples, the diffusion data is a value corresponding to a relative or absolute level of diffusion to apply. For example, a value of 0 might indicate no diffusion (for an image with high spatial frequency components) and 1 might indicate that diffusion is active (for an image with low spatial frequency components). Other examples of diffusion data are possible.

The controller 80 is configured to separate the diffusion data from the input images and provide the input image to an SLM driver 84 for display on an SLM 86. The SLM driver 84 notifies the controller 80 via a signal 88 once the image is formed on the SLM. Next, the Controller 80 provides a signal 90 to a diffusion control element 92 at the same time as activating a laser 94, or other at least partially coherent light source, to illuminate the SLM.

The diffusion control element 92 is configured to activate and deactivate a diffuser depending on a required speckle reduction in the output image according to the diffusion data. In some embodiments, the diffusion control element 92 is also configured to control a level of diffusion provided by the diffuser. For example, when used with the example of FIG. 6, the diffusion control element may control a level of diffusion by selectively activating the ultrasonic mirror and/or adjusting focus. Furthermore, if the diffuser is binary or otherwise has discrete states (such as the steps of FIG. 7), the diffusion control element may selectively activate and deactivate the diffuser or switch between states during display of one image according to the desired diffusion amount, such as by using Pulse Width Modulation. This can enable improved image quality with reduced hardware complexity.

This construction of FIG. 8 allows a single SLM to display the images 11 in sequence with control of diffusion synchronised to the image sequence. Through the use of a hardware control path, accurate and fast synchronisation between the display of the image on the SLM and the appropriate amount of diffusion may be achieved.

Controller 80 is implemented by a Field Programmable Gate Array (FPGA) in FIG. 8, but is not limited to this. Other examples may use an Application Specific Integrated Circuit (ASIC) or an appropriately programmed processing system.

Some examples may combine the functional blocks depicted in FIG. 8 into a single element. For example, any two or all of the Controller 82, SLM Driver 84 and Diffusion Control 92 may be combined.

High Definition Multimedia interface (HDMI) is used to supply image data to the controller in FIG. 8 over input interface 82. Other interfaces may be used in other embodiments, including DisplayPort, Thunderbolt, USB and so on.

In some examples, the diffusion data is independent of the display hardware and the diffusion control 92 or the controller 82 translates the diffusion data to appropriate hardware operation. For example, the diffusion data may be set as predetermined values according to a required level of diffusion and this can be realised using the hardware via the controller 82 and/or the diffusion control 92.

In an alternative construction, the controller 80 may be used to direct images to appropriate hardware depending on the diffusion data. For example the display apparatus may further comprise a non-holographic display, or additional holographic displays with different, pre-determined, levels of diffusion. The controller 80 is provided with connections to all these displays, potentially via an appropriate driver circuit, and directs received image data to an appropriate one depending on the diffusion data. For example, where the example of FIG. 8 further comprises a non-holographic display, then images can be directed to the non-holographic display or the SLM depending on the level of diffusion required (so that images comprising low spatial frequencies, requiring a higher level of diffusion are directed to the non-holographic display).

While the embodiments described herein have been applied to three-dimensional images, they are equally applicable to two-dimensional images displayed holographically. Such two-dimensional images may be associated with a depth, for example a depth of the image plane for display.

The methods described herein may be embodied wholly in software, wholly in hardware or in any combination thereof. Where a software implementation is used, examples may comprise a computer-readable medium, which may be a non-transitory computer-readable medium, comprising computer-executable instructions that, when executed by a processor, instruct the processor to carry out the method.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method for reducing holographic speckle when displaying an image, the method comprising:
displaying the image by combining a first holographic display image and a second display image, the first holographic display image comprising higher spatial frequency components of the image and being generated using a first holographic display method and the second display image comprising lower spatial frequency components of the image and being generated using a second display method, wherein the second display method is adapted to reduce holographic speckle or include no holographic speckle compared to the first holographic display method.

2. The method according to claim 1, wherein the first holographic display image is generated based on a first input image and the second display image is generated based on a second input image, wherein all intensity values of the first and second input images are non-negative.

3. The method according to claim 2, comprising decomposing a target image to generate the first input image and second input image, wherein the first input image and second input image are generated so that the displayed image perceived by a user is substantially the same as the target image.

4. The method according claim 2, comprising decomposing a target image to generate the second input image including lower spatial frequencies of the target image and generating the first input image based on the second input image and the target holographic image.

5. The method according to claim 2, comprising a step of decomposing a target image to generate the first input image, the second input image and an intermediate input image, wherein the first input image includes higher spatial frequencies of the target image than the intermediate input image, and the intermediate input image includes higher spatial frequencies of the target image than the second input image, wherein displaying the image is performed by combining the first holographic display image, the second display image and a third display image, the third display image having been generated using a third display method to display the intermediate input image.

6. The method according to claim 1, wherein the first display image and second display image are combined by displaying the first and second display images in a time sequence so that a viewer perceives the target image as a combination of the first display image and the second display image.

7. The method according to claim 1, wherein first display image and second display image are combined by simultaneously displaying the first and second display images so that a viewer simultaneously receives light from first and second display images.

8. The method according to claim 1, wherein the second display method comprises a second holographic display method in which the second display image is generated having only a single depth.

9. The method according to claim 1, wherein the displayed image is three-dimensional.

10. A display apparatus for reducing holographic speckle when displaying an image, the display apparatus configured to display the image by combining a first holographic display image comprising higher spatial frequency components of the image and a second display image comprising lower spatial frequency components of the image, the display apparatus having a first operation mode to generate the first holographic display image and a second operation mode configured to generate the second display image, wherein the second operation mode is configured to reduce holographic speckle or include no holographic speckle compared to the first operation mode.

11. The display apparatus according to claim 10, wherein the second operation mode is configured to generate images with greater blur than the first operation mode.

12. The display apparatus according to claim 10 configured to display the first holographic display image and second display image in a time-sequence or simultaneously so that they are perceived as a combination of the first holographic display image and second display image.

13. The display apparatus according to claim 12, comprising:
a holographic image generator, the holographic image generator comprising an optical blurring component; and
wherein the second operation mode uses the holographic image generator and the optical blurring component to reduce holographic speckle in the second display image.

14. The display apparatus according to claim 12, comprising:
a holographic image generator, the holographic image generator comprising a processor and a memory configured to process an input image in order to reduce holographic speckle; and
wherein the second operation mode uses the holographic image generator.

15. The display apparatus according to claim 12, comprising:
a non-holographic two-dimensional display,
wherein the second operation mode uses the non-holographic two-dimensional display.

16. The display apparatus according to claim 10, comprising:
a phase-only holographic display;
wherein the first operation mode uses the phase-only holographic display.

17. The display apparatus according to claim 10, comprising:
a holographic display; and
a variable diffuser provided in an optical path of the holographic display;
wherein the first operation mode and the second operation mode use the holographic display and have different blur characteristics in a time sequence by varying a level of diffusion provided by the variable diffuser.

18. The display apparatus according to claim 10, wherein the displayed image is a three-dimensional image.

19. The display apparatus according to claim 10, comprising:
a controller configured to separate image data and associated diffusion data indicative of a level of diffusion required in the image, and to control display of an image with diffusion according to the diffusion data.
